(19) United States
(12) Patent Application Publication
(10) Pub. No.: US 2011/0281193 A1
(43) Pub. Date: Nov. 17, 2011

(54) FUEL CELL FLUID DISTRIBUTION SYSTEM

(75) Inventors: Stéphane Lévesque, Montreal (CA); Raymond Roberge, Boucherville (CA)

(73) Assignee: EnergyOr Technologies Inc., Montreal (CA)

(21) Appl. No.: 13/112,068

(22) Filed: May 20, 2011

Related U.S. Application Data
(63) Continuation-in-part of application No. 11/525,149, filed on Sep. 22, 2006, now abandoned.

(51) Int. Cl. H01M 8/04; H01M 8/24

(52) U.S. Cl. 429/457; 429/514

(57) ABSTRACT

Disclosed herein is a fuel cell having a catalyst coated membrane (CCM) including a membrane sandwiched between an anode layer and a cathode layer; two gas diffusion layers located against respective anode and cathode layers; and two separator plates located against the respective gas diffusion layers. The fuel cell has at least one hydrogen passageway for hydrogen fuel, which extends through the CCM and disposed orthogonal relative to the plane of the layers. The hydrogen fuel is blocked from contacting the cathode layer so that the hydrogen fuel is provided to one side of the anode layer. At least one air/oxygen passageway for air/oxygen fuel extends through the CCM and disposed orthogonal relative to the plane of the layers. The air/oxygen fuel is blocked from contacting the anode layer so that the air/oxygen fuel is provided to one side of the cathode layer. A coolant pathway is in fluid communication with the layers and located to remove heat away from the layers during operation of the fuel cell.

### CROSS-REFERENCE TO RELATED APPLICATIONS

This application claims priority from and is a continuation-in-part application of pending U.S. patent application Ser. No. 11/525,149, filed Sep. 22, 2006, the contents of which are hereby incorporated by reference.

### TECHNICAL FIELD

The present invention relates to fuel cells in general and a distribution system for the reaction gases and fluids to a cell and a stack assembly in particular.

### BACKGROUND

Polymer electrolyte membrane or proton exchange membrane (PEM) fuel cells have intrinsic benefits and a wide range of applications due to the relatively low operating temperatures, room temperature to around 80° C. or higher, up to ˜160° C., with high temperature membranes. The active portion of a PEM is a membrane sandwiched between an anode and a cathode layer. Fuel gas containing hydrogen is passed over the anode and oxygen (air) is passed over the cathode. The gases react indirectly with each other through the electrolyte (the membrane) generating an electrical voltage between the cathode and the anode. Typical electrical potential of PEM cells can be from 0.5 to 0.9 volts, the higher the voltage the greater the electrochemical efficiency, however at lower cell voltage, the current density is higher but there is a peak value in the power density for a given set of operating conditions. The electrochemical reaction also generates heat and water that must be extracted from the fuel cell. The extracted heat can be used in a cogeneration mode. The water can be used for the humidification of the membrane, for the cooling or dispersed in the environment.

Multiple cells are combined by stacking, interconnecting individual cells in electrical series. The voltage generated by the cell stack is the sum of the individual cell voltages. There are designs that use multiple cells in parallel or in a combination series parallel connection. Separator plates (bipolar plates) are inserted between the cells to separate the anode gases of one cell from the cathode gases of the next cell. These separator plates are typically graphite based or metallic with or without coating. To provide hydrogen to the anode and oxygen to the cathode without mixing, a complex system of gas distribution and seals is required.

The dominant design at present in the fuel cell industry is to use bipolar plates with flow field machined, molded or otherwise impressed in the bipolar plates. An optimized bipolar plate has to fulfill a series of requirements; very good electrical and heat conductivity, gas tightness, corrosion resistance, low weight and low cost.

The separator plate flow field design ensures the gas distribution, the removal of product water and the removal of the heat generated. Also required is the design of manifolds for the fluids to ensure that the flow reaches each separator/flow field plate uniformly.

Thus, there is a need to increase the power density (weight and volume) of fuel cell stacks and to reduce material and assembly costs.

### BRIEF SUMMARY

Our invention could lead to a significant innovation radically different from the existing dominant technology. Our invention offers an advantageous alternative to the current industry dominant design of using separator plates with flow fields to distribute the reaction gases in a path parallel to the membrane assembly. In our invention, the reaction gases are fed perpendicularly to the membrane plane from a multitude of separate conduits. Typically, four different conduits (or passageways) (hydrogen in and out and oxygen (air) in and out) are used as the repeatable unit to cover the active area of the membrane. A separate conduit (in/out) for the water cooling can be added or the water cooling could be integrated to the oxygen (air) exhaust or the hydrogen exhaust. We have also located seals to ensure that the anode (hydrogen) fuel is prevented from entering the cathode side of the membrane and to ensure that the cathode air/oxygen is prevented from entering the anode side of the membrane. Among the advantages of the system is that it is scalable without major redesign since the active fuel cell area is subdivided in a repeatable pattern at will. The invention provides the fuel cell and fuel cell stack assembly with a system for fluid distribution. Our system has the following unique elements: Conduits fulfilling both the manifold and flow field functions are positioned perpendicularly to the membrane electrode assembly plane. The active membrane area is subdivided in small areas with their own fuel and oxidant supply. Reaction gases (fuel—hydrogen and oxidant—oxygen/air) are flowing mainly radially and diffusing axially thru porous gas diffusion layer (GDL) to reach the membrane electrode assembly and thus complete the flow field function. The porous gas diffusion layer (GDL) is a thermally conducting material; heat is flowing axially, i.e. from the electrodes to the separator plates. The separator plates are a thermally conducting material acting mainly in a radial direction, i.e. in the membrane electrodes assembly (catalyst coated membrane) plane between conduits. The heat of reaction is extracted by water circulating in the air exhaust conduits (manifolds), separate manifolds and other options are equally possible. The necessary gas tight seals in the GDL are formed in situ to ensure uniformity, reliability, ease of assembly and lower cost.

Accordingly, in one aspect, there is provided a fuel cell having a catalyst coated membrane (CCM) including a membrane sandwiched between an anode layer and a cathode layer; two gas diffusion layers located against respective anode and cathode layers; and two separator plates located against the respective gas diffusion layers, the fuel cell comprising:

a) at least one hydrogen passageway for hydrogen fuel extending through the CCM and disposed orthogonal relative to the plane of the layers, the hydrogen fuel being blocked from contacting the cathode layer so that the hydrogen fuel is provided to one side of the anode layer;

b) at least one air/oxygen passageway for air/oxygen fuel extending through the CCM and disposed orthogonal relative to the plane of the layers, the air/oxygen fuel being blocked from contacting the anode layer so that the air/oxygen fuel is provided to one side of the cathode layer; and

c) a coolant pathway in fluid communication with the layers and located to remove heat away from the layers during operation of the fuel cell.

In one example, the hydrogen fuel flowing in the hydrogen passageway radially diffuses therefrom onto the anode layer, and the air/oxygen fuel flowing in the air/oxygen passageway radially diffuses therefrom onto the cathode layer.

In one example, the fuel cell includes first and second seals, the first seal being integral with one gas diffusion layer and adjacent the anode layer to prevent radial diffusion of the hydrogen fuel from the hydrogen passageway onto the cathode, the second seal being integral with the other gas diffusion layer and adjacent the cathode layer to prevent diffusion of the air/oxygen fuel from the air/oxygen passageway onto the anode. The fuel cell further includes edge seals located around the periphery of the fuel cell and integral with the gas diffusion layers to prevent escape of the hydrogen and air/oxygen from the fuel cell.

In another example, the fuel cell further includes at least one air outlet passageway and at least one hydrogen outlet passageway, the outlet passageways being in fluid communication with the layers. The coolant pathway is separate from the hydrogen and air outlet passageways. The coolant pathway is integral with the hydrogen outlet passageway.

In one example, the passageways are located so that fuel exhaust and cooling fluid are combined in outlet conduits.

In another example, the fuel cell, according to claim 1, in which the passageways are located so oxidant exhaust and cooling fluid are combined in outlet conduits.

In one example, the hydrogen passageways are located so that hydrogen is distributed in a radial direction in the porous gas diffusion layers from the hydrogen passageways to hydrogen outlet passageways.

In another example, the air/oxygen passageways are located so that air/oxygen is distributed in a radial direction in the porous gas diffusion layers from the air/oxygen passageways to air/oxygen outlet passageways.

In another example, the passageways are located so the electrochemical reaction by-product water is removed in a radial direction in the porous gas diffusion layers from the air/oxygen passageways to air/oxygen outlet conduits.

In one example, the seals isolate the anode flow from the cathode flow.

In another example, the passageways are distributed in a repeatable parallelogram unit to create a two dimensional pattern.

In another example, the combined cross-sectional area of the passageways total between about 10 and 50 percent of the total active area of the fuel cell.

According to another aspect, there is provided a fuel cell stack of two or more fuel cells connected in series, the stack comprising:

a) a plurality of fuel cells, as described above;

b) a plurality of separator plates located between each fuel cell, each separator plate having separator plate openings matching the passageways in each fuel cell;

c) two fluid distribution manifolds with fluid flows that register with the openings in the separator plates and the passageways in the fuel cells, the fluid distribution manifolds having external ports for fluid inlet and fluid outlet; and

d) two current collectors and two end plates located on opposing sides of the said plurality of fuel cells to maintain the stack under compression.

In one example, the fluid distribution manifold and the end plate function separately.

In another example, the fluid distribution manifold function and the end plate function as an integrated component. The separator plates material is selected from graphite, flexible graphite, expanded graphite, electrically conductive composites, coated metallic, or uncoated metallic.

Accordingly, there is provided a solid electrolyte membrane fuel cell comprising a plurality of conduits that penetrate the catalyst coated membrane and the porous gas diffusion layers in a perpendicular direction to the catalyst coated membrane plane, the conduits have appropriately positioned integrated gaskets to provide reactant gases to the anode or cathode and to ensure that the anode fuel is prevented from entering the cathode side of the membrane and vice-versa, a water cooling path to extract the heat from the electrochemical reaction, each conduit is fully separated from each other by an active area of the solid electrolyte membrane.

Accordingly, there is provided a fuel cell stack of two or more fuel cells connected in series, the stack comprising a plurality of fuel cells, a plurality of separator plates between each fuel cell with openings matching the conduits in the individual fuel cells, two fluid distribution manifolds with fluid flows that register with the openings in the separator plates and the conduits in the fuel cells, said fluid distribution manifolds having external ports for the fluids inlets and outlets, two current collectors, two end plates disposed on opposing sides of the said plurality of fuel cells to maintain the stack under compression.

### BRIEF DESCRIPTION OF THE DRAWINGS

In order that the invention may be readily understood, embodiments of the invention are illustrated by way of example in the accompanying drawings.

FIG. 1 is a top view of a portion of a single fuel cell;

FIG. 2 is a cross sectional view taken along line 2-2 of FIG. 1;

FIG. 3 is a perspective partial cutaway view of a basic fuel cell stack assembly;

FIG. 4 is a perspective view of a manifold;

FIG. 5 is a perspective view an alternative design of a stacked fuel cell;

FIG. 6 is an exploded view of a modular end plate with flow distribution; and

FIG. 7 is a perspective exploded view of the stacked fuel cell of FIG. 5.

### DETAILED DESCRIPTION

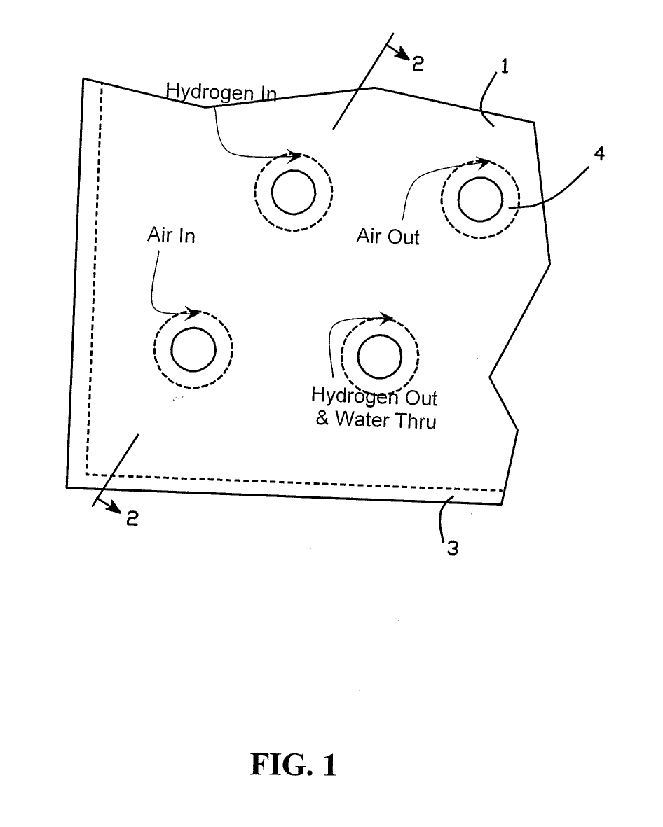

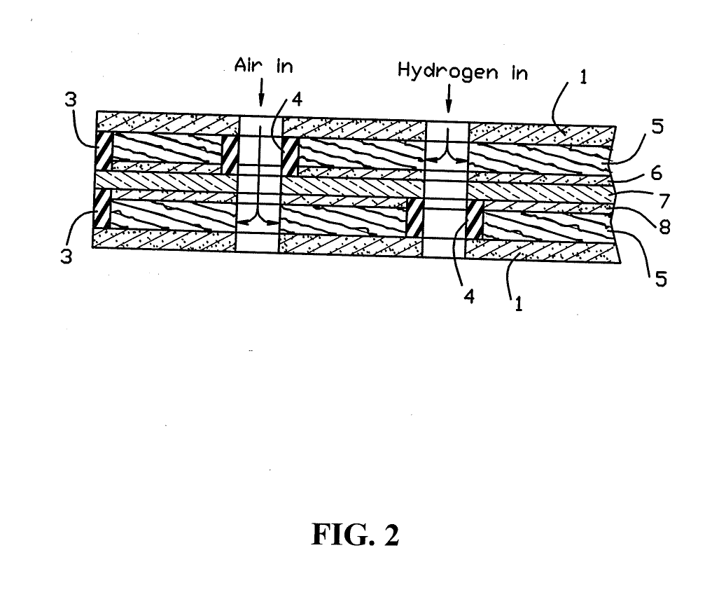

Referring now to FIGS. 1 and 2, a single solid electrolyte membrane fuel cell is illustrated showing spaced apart air in, air out, hydrogen in, hydrogen out and water thru feed conduits (passageways). For illustration purposes only, a top view of a portion of the fuel cell shows a separator plate 1, and the location of in-situ seals (gasket) 4 and edge seals (gaskets) 3.

As best seen in FIG. 2, when viewed in cross section, the single fuel cell has a catalyst coated membrane (CCM), which includes a proton exchange membrane 7 sandwiched between an anode catalyzed layer 6 and a cathode catalyzed layer 8. Two porous gas diffusion layers (GDL) 5, also known as gas diffusion media or porous gas diffusion media, face, and are located against, the anode layer 6 and the cathode layer 8. The GDL distributes the reaction gases (hydrogen and air/oxygen) uniformly over the active area of the membrane and extracts water and heat during the electrochemical reaction. The gas diffusion layer porosity is between 60 and 90 percent. The porous gas diffusion layer has an average pore size of between 5 and 50 microns. The porous gas diffusion layer thickness is between 50 and 500 microns. The catalyst coated membrane is periluorosulfonic acid polymer based, a poly-benzimidazole (PBI) temperature resistant polymer, an engineered hydrocarbon membrane or a sulfonated poly ether ether ketone (SPEEK). The porous gas diffusion layer's material is hydrophobic. The porous gas diffusion layers material has hydrophobic region in contact with the catalyst coated membrane and has hydrophilic region in contact with the separator plates.

Still referring to FIG. 2, although a plurality of feed conduits (or passageways) are typically used in the single fuel, a single hydrogen in passageway for hydrogen fuel and a single air/oxygen in passageway for air/oxygen fuel will be described in detail. The hydrogen passageway for hydrogen fuel extends through the CCM and disposed orthogonal (perpendicular) relative to the plane of the layers of the CCM and the two GDLs. The air/oxygen passageway for air/oxygen fuel also extends through the CCM and the two GDLs and is disposed orthogonal relative to the plane of the layers. This assembly is referred to as the MEA (membrane electrode assembly). A separator plate 1 (two are illustrated in FIG. 2), also referred to as bipolar plate (sheet, foil), is inserted to separate each cell. The hydrogen fuel is blocked from contacting the cathode layer so that the hydrogen fuel is provided to one side of the anode layer, whereas the air/oxygen fuel is blocked from contacting the anode layer so that the air/oxygen fuel is provided to one side of the cathode layer. The GDL 5 includes two seals 4. One seal 4 is integral with one gas diffusion layer and adjacent the anode layer 6 to prevent radial diffusion of the hydrogen fuel from the hydrogen passageway onto the cathode layer 8. The second seal 4 is integral with the other gas diffusion layer and adjacent the cathode layer 8 to prevent diffusion of the air/oxygen fuel from the air/oxygen passageway onto the anode layer 6. The GDL 5 includes seals 4 which prevent mixing of the reaction gases. Because of the location of both the seals 4, the hydrogen fuel flowing in the hydrogen passageway radially diffuses therefrom onto the anode layer, and the air/oxygen fuel flowing in the air/oxygen passageway radially diffuses therefrom onto the cathode layer. Thus, the seals fully isolate the anode flow from the cathode flow. The seals are fabricated in situ with a material which is compatible with the membrane and the catalyst coated layer.

In our design, the seals are produced in situ, thus ensuring the necessary gas tightness and simplifying the assembly. The fuel cell also includes the edge seals 3 which are located around the periphery of the fuel cell and integral with the gas diffusion layers to prevent escape of the hydrogen and air/oxygen from the fuel cell.

The conduits are located so the fuel (hydrogen or hydrogen rich mixture) is distributed in a radial direction in the porous gas diffusion layers from fuel inlet conduits to fuel outlet conduits. The conduits are located so the oxidant (air/oxygen) is distributed in a radial direction in the porous gas diffusion layers from oxidant inlet conduits (air/oxygen passageways) to oxidant outlet conduits.

The conduits are located so the electrochemical reaction by-product water is removed in a radial direction in the porous gas diffusion layers from air/oxygen inlet conduits to air/oxygen outlet conduits using a coolant pathway, which is in fluid communication with the layers. The coolant pathway is also located to remove heat away from the layers during operation of the fuel cell.

In one example, the conduits are located so the oxidant exhaust and cooling fluid are combined in outlet conduits. In another example, the conduits are located so the fuel exhaust and cooling fluid are combined in outlet conduits.

The conduit (passageway) geometry provides uniform distribution of the fuel reactants. The conduit size is between about 1 to 5 mm. The conduits are distributed in a repeatable parallelogram unit to create a two dimensional pattern. The combined cross-sectional area of the conduits total between about 10 and 50 percent of the total active area of the fuel cells. The conduits are located so the oxidant (oxygen/air) is distributed in a radial direction in the porous gas diffusion layers from oxidant inlet conduits to oxidant outlet conduits. The conduits are located so the electrochemical reaction by-product water is removed in a radial direction in the porous gas diffusion layers from air/oxygen inlet conduits to air/oxygen outlet conduits. The conduits are located so the oxidant exhaust and cooling fluid are combined in outlet conduits. The conduits are located so the fuel exhaust and cooling fluid are combined in outlet conduits. The gaskets fully isolate the anode flow from the cathode flow.

The gaskets are fabricated in situ with a material which is compatible with the membrane and the catalyst coated layer. The gasket material is selected from the group consisting of: silicone based elastomers, silicone based elastomers with inert additives, polyurethane elastomers, polyurethane elastomers with inert additives, thermoset elastomers, and thermoset elastomers with inert additives. The inert additives can be carbon based, silicon dioxide based, aluminum oxide based, or ceramic based.

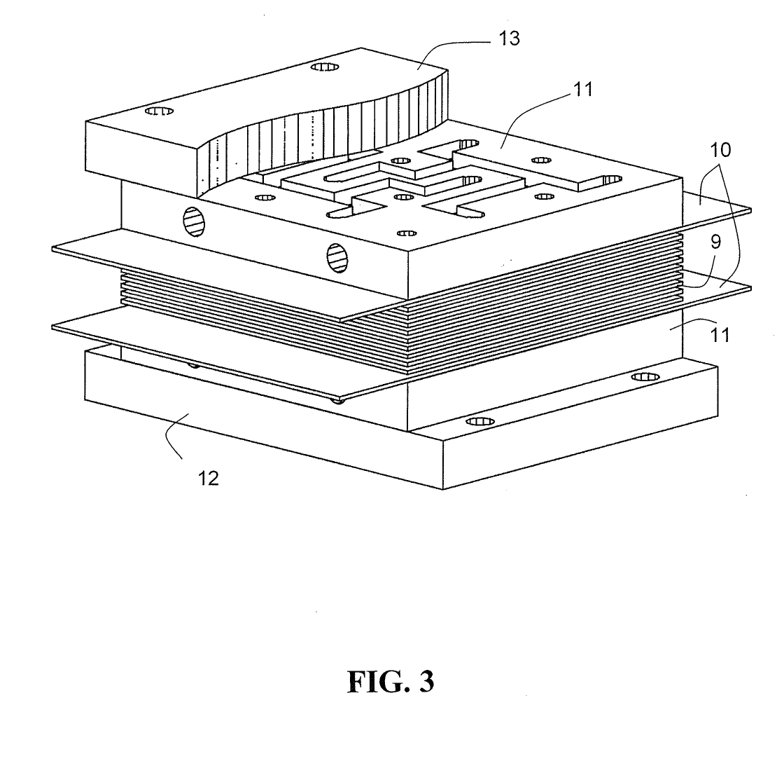

Referring now to FIG. 3, a basic fuel cell stack assembly is illustrated in which fuel cells 9 are stacked and interconnected in electrical series. Current collectors 10 are inserted between the stacked fuel cells and two fluid distribution manifolds 11. A bottom end plate 12 and a top end plate 13 (shown partially cutaway for ease of illustration) are located against their respective fluid distribution manifolds 11. Connecting rods (not shown) or indeed any other conventional connecting means hold the assembly together and maintain pressure on the stack. The basic fuel cell assembly parameters of geometry, size, spacing and spatial arrangements can be modified according to use.

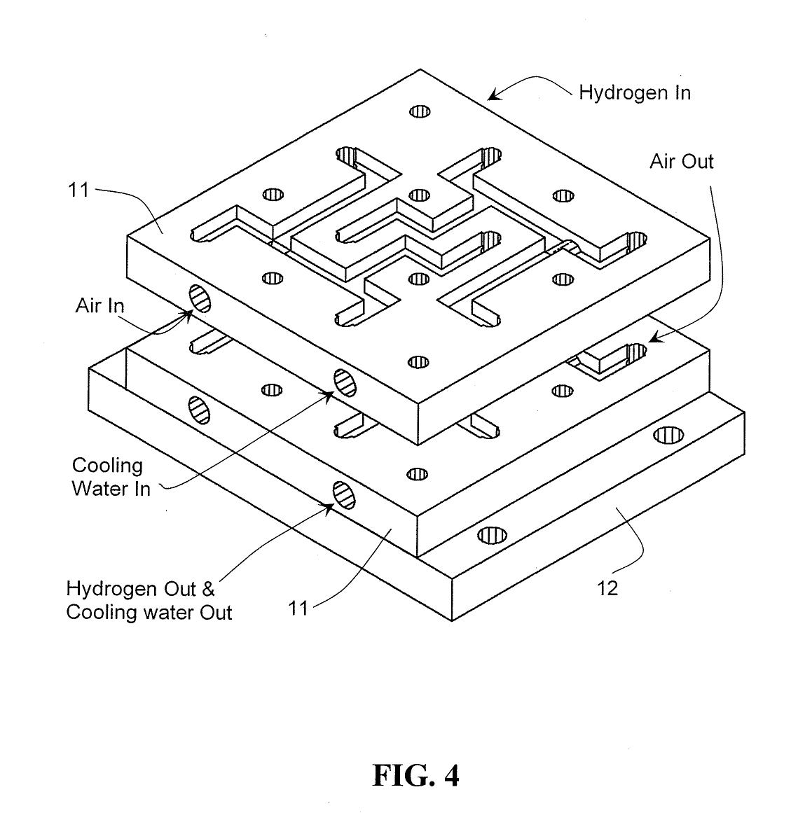

Referring now to FIG. 4, the fluid distribution manifold 11 and the bottom end plate 12 are illustrated showing the air in conduit, the air out conduit, the hydrogen in conduit, the cooling water in conduit and the hydrogen out conduit combined with the water out conduit.

FIGS. 3 and 4 illustrate a stack assembly with a basic concept of the fluid distribution. Once the membrane and the porous gas diffusion media have been selected, in the present case Nafion™ membrane and GDL from SGL Carbon Group, the catalyst coated membrane (membrane plus platinum) and the porous gas diffusion media are pressed together according to the recommendation of the manufacturers regarding temperature, pressure and time. The geometry, size and number of conduits are selected based on the operating conditions and the required power per cell and total power. The first step is then to prepare the assembly CCM-GDL for the integrated gaskets on the anode and cathode side of the membrane and to mold the gaskets. The final step prior to assembly is to pierce the gaskets and membrane. The assembled individual fuel cells are then stacked inserting a separator/bipolar plate between each cell. Current collectors 10 complete the stack, the fluid distribution manifold 11 is then added and finally the end plates 12, 13 and tie-rods (not illustrated) compress the stack. Fittings for oxygen/air, hydrogen, and water are then attached to the manifold and the stack is ready to be put in operation.

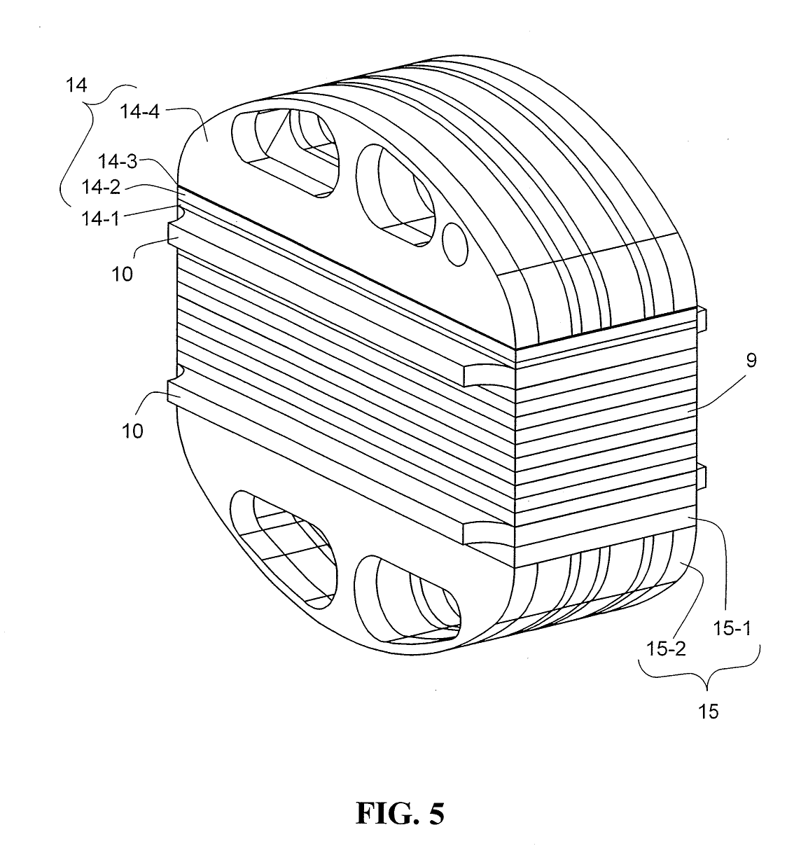

Referring now to FIG. 5, an alternative design of a fuel cell stack assembly is illustrated in which the distribution manifolds and end plates, as described above, are integrated into a single component. The plurality of fuel cells 9 are stacked and individual cells interconnected in electrical series. The current collectors 10 are located between the stack and a distribution manifold/end plate integrated component inlet 14 and distribution manifold/end plate integrated component outlet 15. The inlet 14 includes four plates, namely a perforated distribution plate 14-1 with three types of feed conduits, which includes one type for air, one type for hydrogen and one type for water; a manifold 14-2 to feed the hydrogen fuel in the designated conduits; a separator plate 14-3 located between the hydrogen manifold and the other manifolds, and an inlet fluid distribution 14-4. The outlet 15 includes a perforated distribution plate 15-1 and outlet manifolds 15-2 for air, hydrogen and water combined. Advantageously, this alternative design is simpler in construction, lighter and more rigid than the design illustrated above.

Still referring to FIG. 5, the catalyst coated membrane and the porous gas diffusion media, in the present case Ion-Power CCM with Nafion™ membrane, and SGL 34BC GDL, are pressed together according to the recommendation of the manufacturers regarding temperature, pressure and time. The geometry, size and number of conduits are selected based on the operating conditions and the required power per cell and total power. The assembly CCM-GDL is prepared by mechanically making the openings in the GDL for the integrated gaskets on the anode and cathode side of the membrane. A silicone based product with an inert carbon base additive is injected and the gaskets are cured. The final step prior to assembly is to pierce the gaskets together with the CCM and the GDL on the opposite side.

The assembled individual fuel cells 9 are then stacked. Current collectors 10 complete the stack. In this example, the combination fluid distribution manifold and end plates 14 are added and the system is compressed by elastic wrapping around the stack, not shown in the figure. Fittings for oxygen/air, hydrogen and water are then attached to the manifold and the stack is ready to be put in operation.

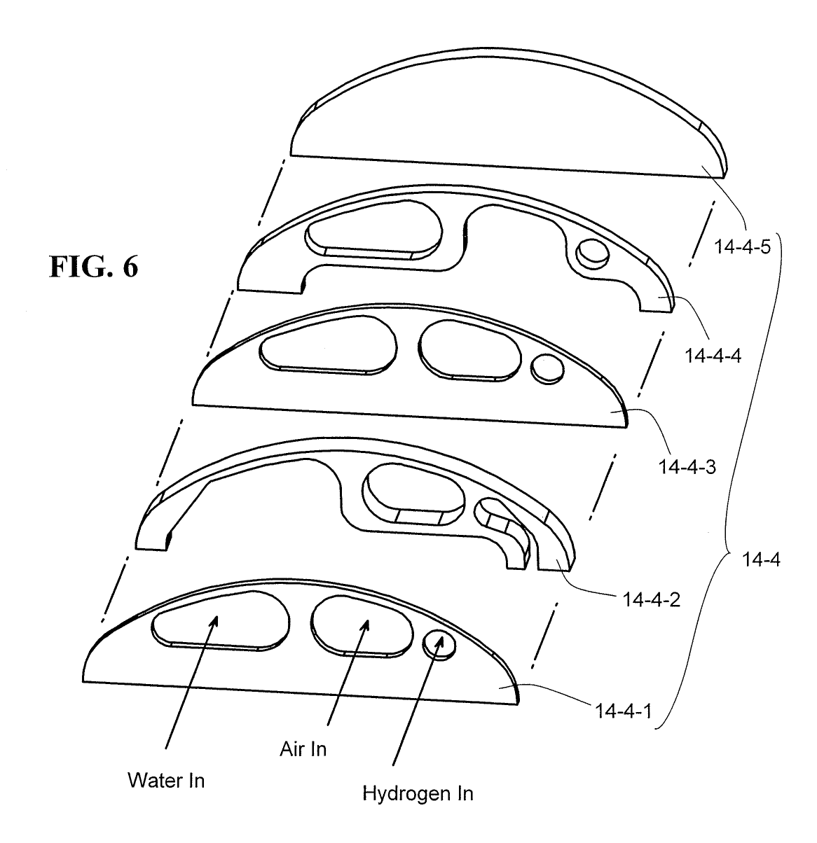

Referring now to FIG. 6, the inlet fluid distribution 14-4 is a modular end plate, which includes a face plate 14-4-1, which is the connecting plate (interface) for the water-in, air-in and hydrogen-in conduits. A first separator plate 14-4-2 is located against the face plate 14-4-1 and is the distribution manifold for water in and hydrogen in. A second separator plate 14-4-3 is located against the first separator plate 14-4-2 and allows flow of water, air, and hydrogen. A fourth separator plate 14-4-4 is located against the third separator plate 14-4-3 and is the distribution manifold for air in. A combination distribution manifolds/end plate 14-4-5 is located against the fourth separator plate 14-4-4 and seals the manifold.

Referring still to FIG. 6, the combination end plate (structural function) and manifold (fluid distribution) 14-4. This design combines two functions—structural and fluid distribution. It is lighter than the design with separate component and easier to manufacture and lower cost of the manifold. It has more flexibility in the design and provides more uniform distribution of the fluids.

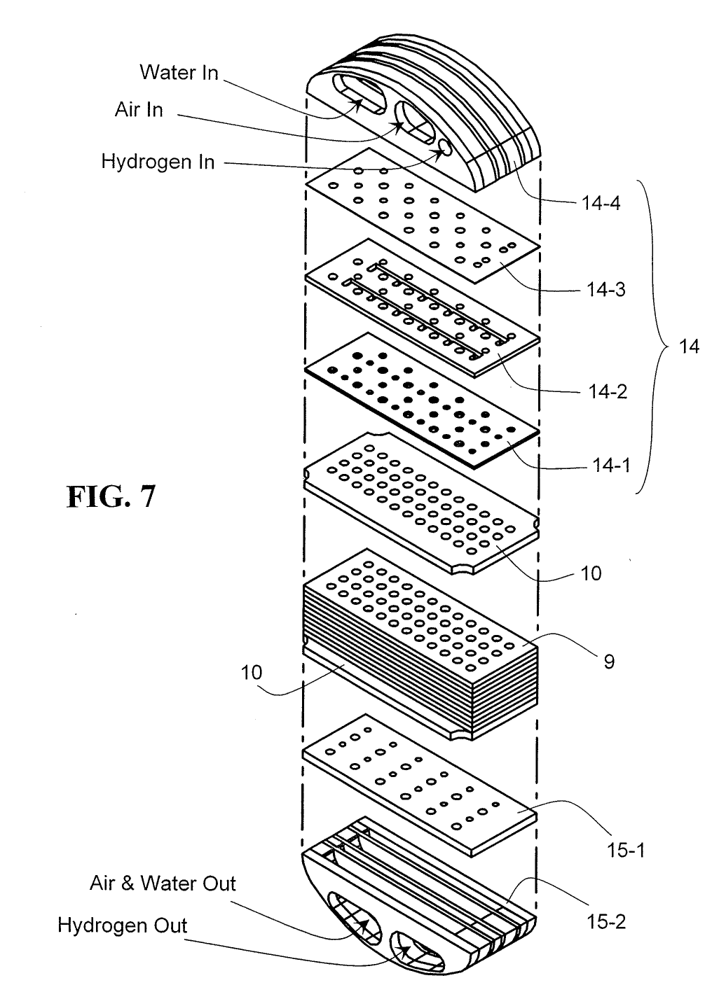

Referring to FIG. 7, which illustrates a plurality of single cell 9 connected in series with a plurality of conduits with integrated gaskets (seals), the current collectors 10, the flow distribution and end plates combination inlet 14 and outlet 15. Forty eight conduits are shown for illustrative purposes only, although a person of ordinary skill in the art will understand that more or less can be used. The conduits are illustrated as a pattern which is a rectangular matrix; however other geometries can also be used. In this example, three separate conduits are used for the inlet and two for the outlet, therefore the cooling conduits can be either combined with the air or hydrogen exhaust, in the illustration air and water are combined. As described above, the core of the fuel cell is the catalyst coated electrolyte membrane (6+7+8), sandwiched between the cathode GDL 5 and the anode GDL 5. Each cathode layer and anode layer has integrated gaskets; on cathode side 4 and on anode side 4. These integrated gaskets ensure that the anode fuel is prevented from entering the cathode side of the membrane and the air/oxygen is prevented from entering the anode side. The water cooling conduits in this example are combined with the air exhaust conduits which is also the exhaust for the reaction water. The first and the last cell are connected in series with the current collectors 10. The distributor plates 14-1, 14-2, and 14-3, are inserted between the current collector 10 and the fluid manifold 14-4.

The fluid distribution manifold function and end plate mechanical function are accomplished by separate components. The fluid distribution manifold function and end plate mechanical function are combined in an integrated component. The separator plates and the bipolar plates are made from material which is both a good electrical conductor to connect electrically the individual cells and a good thermal conductor to extract the heat of reaction in mostly radial direction toward the cooling water circulation conduits. The separator plates material is selected from graphite, flexible graphite, expanded graphite, electrically conductive composites, coated metallic, or uncoated metallic.

FIGS. 5, 6 and 7 illustrate a variant of the basic concept in which modifications are in the fluid manifold and end plate design.

### In Situ Seals

One example of a process to locate the in situ seals (or gaskets) is as follows. The catalyst coated membrane and the gas diffusion layers can either be pre-assembled by pressing under a specified set of temperature, time and pressure or the catalyst coated membrane and the gas diffusion layers are handled separately. The conduit's geometry, size and spacing are all variables that can be selected according to use. The selection is determined to some degree by the application, the operating parameters and the auxiliary equipments. The gas diffusion layers are then accurately perforated to match the seal's location. The appropriate sealing material is prepared and injected in the openings (perforations in the GDL) and cured. The gasket material is selected for the compatibility with the membrane and the catalysts, and to have the required mechanical, thermal, electrical and viscous properties to provide an adequate seal in reference to gas tightness, mechanical strength durability and reliability. The edge seals can also be located using a number of alternatives. Once the integrated gaskets are formed the assembly CCM+GDL+separator plates are perforated. The individual cells with the plurality of conduits are then ready for assembly. Again numerous alternatives are possible to align and compress the stack of cells. Current collectors are positioned at each extremity and the manifold—end plate combination completes the stack assembly. Pressure is applied and maintained by mechanical means. Two examples are described as illustrative of the many possibilities can be proposed by a person skilled in the art.

Although the above description relates to a specific preferred embodiment as presently contemplated by the inventor, it will be understood that the invention in its broad aspect includes mechanical and functional equivalents of the elements described herein.

What is claimed is:

1. A fuel cell having a catalyst coated membrane (CCM) including a membrane sandwiched between an anode layer and a cathode layer; two gas diffusion layers located against respective anode and cathode layers; and two separator plates located against the respective gas diffusion layers, the fuel cell comprising:
a) at least one hydrogen passageway for hydrogen fuel extending through the CCM and disposed orthogonal relative to the plane of the layers, the hydrogen fuel being blocked from contacting the cathode layer so that the hydrogen fuel is provided to one side of the anode layer;
b) at least one air/oxygen passageway for air/oxygen fuel extending through the CCM and disposed orthogonal relative to the plane of the layers, the air/oxygen fuel being blocked from contacting the anode layer so that the air/oxygen fuel is provided to one side of the cathode layer; and
c) a coolant pathway in fluid communication with the layers and located to remove heat away from the layers during operation of the fuel cell.

2. The fuel cell, according to claim 1, in which the hydrogen fuel flowing in the hydrogen passageway radially diffuses therefrom onto the anode layer, and the air/oxygen fuel flowing in the air/oxygen passageway radially diffuses therefrom onto the cathode layer.

3. The fuel cell, according to claim 1, includes first and second seals, the first seal being integral with one gas diffusion layer and adjacent the anode layer to prevent radial diffusion of the hydrogen fuel from the hydrogen passageway onto the cathode, the second seal being integral with the other gas diffusion layer and adjacent the cathode layer to prevent diffusion of the air/oxygen fuel from the air/oxygen passageway onto the anode.

4. The fuel cell, according to claim 3, further includes edge seals located around the periphery of the fuel cell and integral with the gas diffusion layers to prevent escape of the hydrogen and air/oxygen from the fuel cell.

5. The fuel cell, according to claim 1, further includes at least one air outlet passageway and at least one hydrogen outlet passageway, the outlet passageways being in fluid communication with the layers.

6. The fuel cell, according to claim 5, in which the coolant pathway is separate from the hydrogen and air outlet passageways.

7. The fuel cell, according to claim 5, in which the coolant pathway is integral with the hydrogen outlet passageway.

8. The fuel cell, according to claim 1, in which the passageways are located so that fuel exhaust and cooling fluid are combined in outlet conduits.

9. The fuel cell, according to claim 1, in which the passageways are located so oxidant exhaust and cooling fluid are combined in outlet conduits.

10. The fuel cell, according to claim 1, wherein the hydrogen passageways are located so that hydrogen is distributed in a radial direction in the porous gas diffusion layers from the hydrogen passageways to hydrogen outlet passageways.

11. The fuel cell, according to claim 1, wherein the air/oxygen passageways are located so that air/oxygen is distributed in a radial direction in the porous gas diffusion layers from the air/oxygen passageways to air/oxygen outlet passageways.

12. The fuel cell, according to claim 1, in which the passageways are located so the electrochemical reaction by-product water is removed in a radial direction in the porous gas diffusion layers from the air/oxygen passageways to air/oxygen outlet conduits.

13. The fuel cell, according to claim 2, in which the seals isolate the anode flow from the cathode flow.

14. The fuel cell, according to claim 1, in which the passageways are distributed in a repeatable parallelogram unit to create a two dimensional pattern.

15. The fuel cell, according to claim 1, in which the combined cross-sectional area of the passageways total between about 10 and 50 percent of the total active area of the fuel cell.

16. A fuel cell stack of two or more fuel cells connected in series, the stack comprising:
a) a plurality of fuel cells, according to claim 1;
b) a plurality of separator plates located between each fuel cell, each separator plate having separator plate openings matching the passageways in each fuel cell;
c) two fluid distribution manifolds with fluid flows that register with the openings in the separator plates and the passageways in the fuel cells, the fluid distribution manifolds having external ports for fluid inlet and fluid outlet; and
d) two current collectors and two end plates located on opposing sides of the said plurality of fuel cells to maintain the stack under compression.

17. The stack, according to claim 16, in which the fluid distribution manifold and the end plate function separately.

18. The stack, according to claim 16, in which the fluid distribution manifold function and the end plate function as an integrated component.

19. The stack, according to claim 16, in which the separator plates material is selected from graphite, flexible graphite, expanded graphite, electrically conductive composites, coated metallic, or uncoated metallic.
